(19) United States
(12) Patent Application Publication
(10) Pub. No.: US 2005/0187863 A1
(43) Pub. Date: Aug. 25, 2005

(54) Method and system for protecting real estate from fraudulent transactions

(76) Inventors: Christopher S. Whinery, Edmond, OK (US); Jason Chartrand, Oklahoma City, OK (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 10/784,110

(22) Filed: Feb. 20, 2004

(51) Int. Cl. G06F 17/60

(52) U.S. Cl. 705/39

(57) ABSTRACT

Methods and systems for protecting a true owner's equity in real estate from fraudulent conveyance, mortgaging or other fraudulent transactions comprise executing and recording a lien on the real estate wherein the lien specifies that the lien holder should be contacted and a payoff statement obtained from the lien holder prior to closing any sale, mortgage or other transaction involving the real estate. Personal evidence of the true owner's identity is compiled, a security pass is generated, and this information is documented. When the lien holder is notified of a pending transfer or encumbrance, the lien holder verifies that the one attempting to transfer or encumber the real estate is the true owner based on the compiled personal evidence and security pass.

### BACKGROUND OF THE INVENTION

1. Field of the Invention

The present invention relates to a method for protecting real estate and an individual's equity therein, and particularly a homeowner's equity in his or her home, against the fraudulent transfer of the real estate and/or against fraudulently obtained loans and other transactions in which the real estate is used as collateral.

2. Background of the Invention

Fraud and forgery in the real estate business have had increasing publicity in the past decade. Mortgages have been issued for non-existent houses and to people with forged identities. Schemes have been uncovered where real estate agents kept the sale proceeds and never paid or discharged the original mortgages. In other cases, property has been sold or encumbered by an imposter without the true owner's knowledge of the sale or encumbrance, resulting in very confusing, frustrating and costly circumstances for the true owner.

A particular concern is fraud against a homeowner wherein the identity of the homeowner is fraudulently assumed by an imposter. Criminals can readily search public records to obtain information relating to a specific home address, the equity in that home, mortgages on the property, and the name, social security number, etc., of the homeowner. The criminal can then obtain fraudulent identification papers duplicating the homeowner's identification and sell, mortgage or otherwise encumber the homeowner's residence. For example, once the criminal finds a house that is clear of liens or has substantial equity, the criminal may assume the homeowner's identification and mortgage the property in exchange for a cashier's check. If the criminal requests use of a postal box or otherwise diverts the homeowner's mail, the homeowner may not become aware of the situation until the new mortgage holder forecloses on the property for lack of payment. The homeowner may be evicted and required to prove in court that the new loan was fraudulently obtained.

The same criminal could optionally transfer the property to another financially sound and unknowing person. With false identification, the criminal can sell or transfer the property to an innocent buyer. By the time the true owner and the innocent buyer learn about the fraud, the criminal has disappeared with the sale funds.

It is often possible to eventually clear a fraudulent transaction. However, it may be difficult or impossible to recover court costs, attorney fees, and out-of-pocket expenses due to the fraud. Although it may be possible to purchase title insurance covering some of these situations, such insurance can be expensive and may be limited to specific acts or limited in terms of the amount of loss covered. Thus, there is a need for an improved method of protecting real estate and a true owner's equity therein from fraudulent conveyance, mortgaging or other fraudulent transactions involving the real estate.

### SUMMARY OF THE INVENTION

The present invention provides methods for protecting ownership of real estate and equity in real estate. A method of the present invention for protecting real estate and/or a true owner's equity in real estate from fraudulent conveyance, mortgaging or other fraudulent transactions and encumbrances involving the real estate comprises the following steps. A written instrument comprising a lien on the real estate is executed. The written instrument is recorded so as to give public notice according to applicable laws and regulations. Personal information evidencing the true owner's identity, hereinafter referred to as “security information,” is compiled and documented. When notice of a pending transfer or encumbrance of the real estate is received, verification is obtained, using the security information, that the one attempting to transfer or encumber the real estate is in fact the true owner.

Additionally, the current invention provides a real estate equity protection system comprising a written instrument; means for documenting and maintaining security information as evidence of a true owner's identity; and means for confirming, upon receiving notice of a pending sale, mortgage or other transaction involving the real estate, the true owner's identity based on the documented security information, and for confirming that the true owner is aware of, and is not being fraudulently represented in, the sale mortgage or other transaction. The written instrument is recordable so as to provide public notice, and comprises a mortgage whereby a lien on the real estate is provided to a service company in exchange for a loan of money or a valuable service to a true owner of the real estate.

Other features and advantages of the present invention will be readily apparent to those skilled in the art upon a reading of the description of preferred embodiments which follows when taken in conjunction with the accompanying drawings.

### BRIEF DESCRIPTION OF THE DRAWINGS

FIG. 1 is a flow chart depicting steps in a method for protecting real estate and equity therein from fraudulent transactions and encumbrances.

### DESCRIPTION OF PREFERRED EMBODIMENTS

The present invention provides methods for protecting against fraudulent conveyances of real estate and/or encumbrances against real estate. A method of the present invention for protecting real estate and/or a true owner's equity in real estate from fraudulent conveyance, mortgaging or other fraudulent transactions and encumbrances involving the real estate comprises the following steps. A written instrument comprising a lien on the real estate is executed. The written instrument is recorded so as to give public notice according to applicable laws and regulations. Personal and private information evidencing the true owner's identity, hereinafter referred to as “security information,” is compiled and documented. When notice of a pending transfer or encumbrance of the real estate is received, verification is obtained, based on the security information, that the one attempting to transfer or encumber the real estate is in fact the true owner.

As used herein, the term “real estate” means “land and anything permanently affixed to the land, such as buildings, fence, and those things attached to the buildings such as lighting fixtures, plumbing and heating fixtures, or other such items which would be personal property if not attached.” All deeded real property can be protected by the methods of this invention. Specific examples of the types of real estate that can be protected by the methods of this invention include, but are not limited to, unimproved land, private homes, private rental property, commercial rental property, commercial business parks, farm, industrial plants and municipally owned parks. Most typically, the real estate is a private home.

The term “true owner” is used herein to mean the person, or persons, who without fraud, either own the property outright, own the property subject to a mortgage, or the person or persons who, without fraud, will own the property upon payment of a mortgage thereon. The term “fraudulent transactions” is used herein to include fraudulent home equity loans, mortgages, and liens in addition to fraudulent transfers of the real estate.

The term “lien” as used herein means the right, as acquired by contract, to retain property for payment of some debt, obligation or duty. The written instrument comprising the lien preferably specifies that the lien holder must be contacted and notified prior to closing any mortgage, conveyance or encumbrance involving the real estate. The name and contact information for the lien holder is preferably included in the written instrument. Although the notice requiring contact and lien release may not be legally binding, common practice would include at least contacting and notifying the lien holder in order to obtain a true and correct payoff statement and/or balance. This is customary and necessary in refinance or purchase transactions in order to determine the exact payoff amount. In the event of subordinate financing, it is customary to get a payoff statement in order to calculate a “combined loan to value,” commonly referred to as a CLTV. This exact CLTV is often required for underwriting approval, to obtain title insurance, property insurance and to meet government insurance requirements.

Preferably, the written instrument specifies that the lien must be paid prior to the closing of any sale, mortgage or other transaction involving the real estate. More preferably the written instrument includes notice that the lien can be released only by obtaining a payoff statement from the lien holder. Payoff statements are commonly used in closing procedures to convey the exact payoff amount and other instructions regarding payoff to the entity in charge of closing. The term “closing” is defined herein as the final steps of a transaction wherein the transaction includes home equity loans, mortgages, liens and other refinancing, in addition to the sale or transfer of the real estate. Any instructions in the payoff statement are customarily followed closely by the entity in charge of closing. The payoff statement of this invention will include the exact payoff amount and instructions regarding the requirement for security information to be verified by the lien holder at or before closing.

In one embodiment of the invention, the requirement of a specific closing pass is included in the payoff statement. This closing pass is given to the true owner by the lien holder once the true owner's identity is verified by the lien holder. The true owner is then instructed to bring the closing pass to the closing meeting. The actual closing pass is disclosed in the payoff statement along with the requirement that the entity in charge of closing verify the true owner's knowledge of the pass. Alternatively, the payoff statement may not disclose the actual closing pass but rather require the entity in charge of closing to obtain the pass from the true owner and then verify the accuracy of the true owner's closing pass with the lien holder prior to closing. Examples of closing passes include, but are not limited to, letters, words, numbers, symbols, designs and combinations thereof.

In another embodiment of the invention, the written instrument comprising the lien includes notice that in the event of a title or abstract search on the real estate by a real estate professional, the professional is requested to notify the lien holder. In this case, the instrument typically refers specifically to professionals such as a real estate agent, a closing agent, a title company or an attorney. Again, whether or not enforceable, such notice should encourage a real estate professional to contact the lien holder when engaged in a transaction involving the real estate. Such contact alerts the lien holder that a transaction involving the real estate is under way and that the true owner should be contacted to confirm that he or she is aware of the pending transaction.

In yet another embodiment of the invention, the written instrument further includes language identifying the lien as a means to prevent identity theft and fraud, thus further encouraging compliance with the contact and any specified lien release requirements. Emphasizing the fraud prevention purpose of the lien boldly on the front of the lien instrument should additionally discourage and deter criminal activity when scanned by a potential criminal for criminal purposes.

The written instrument is recorded in the proper registry of deeds or otherwise as necessary to provide public notice of the lien and its required release. In many states, the county recorder's office for the county in which the real estate is located is the repository for important public records such as real estate deeds and lien documents including mortgages.

Personal evidence of the true owner's identity is compiled and documented and preferably includes private information known only by the true owner and trusted associates. This personal information, or “security information,” can be similar to the questions and answers used to verify an Internet application user. Preferably the security information is not readily accessible to the public and is not readily forgotten by the true owner. Examples of such information include, but are not limited to, employer, mother's maiden name, father's middle name, pet's name, name of best friend in grade school, schools attended and dates, musical instruments played, birth date, birth city, ethnic background, race, eye color, and combinations thereof. Preferably, the true owner will provide some of the most private and therefore most useful questions for use as security information.

Evidence of the true owner's identity can also include names and contact information of individuals who can testify to the true owner's identity. For example, a friend, relative or neighbor may be able to identify the true owner from sight or from a photograph or picture.

In a preferred embodiment, the true owner will be given an individual code, hereinafter referred to as a “security code,” as part of the security information compilation process. Example security codes include, but are not limited to, a number, letter, word, symbol, design or combination thereof. The true owner will be told to keep the security code in a safe and private place, such as an individual safety deposit box. The security code is a major piece of the security information and will be required to prove the true owner's identity.

Typically the security information is obtained through an interview process and is stored in a manual filing system and more preferably on a computer system having appropriate backup. Preferably the security information is periodically analyzed and updated. For example, the true owner's address, phone, employer, and similar information may be updated every two years. During this review, if a security code was issued as part of the security information, the true owner should be asked where it is kept, and if it is lost, a new security code may be issued.

Typically, the lien will be released if the one attempting to transfer or encumber the real estate is the true owner as verified by the closing pass and/or the security information.

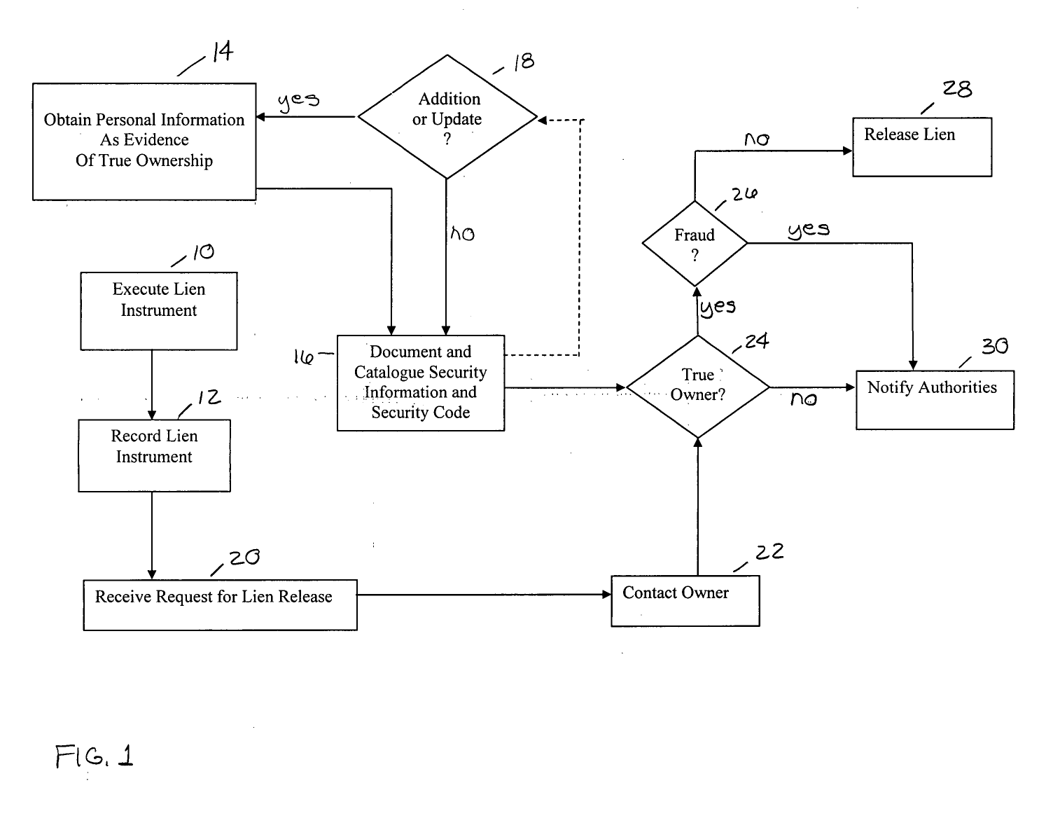

Referring to FIG. 1, a method of the present invention for protecting real estate and/or a true owner's equity therein from fraudulent transactions and encumbrances comprises the following steps. A lien instrument is executed at block 10 wherein a lien on the real estate is obtained by a lender in exchange for a loan of money, or other valuable consideration or services, to a true owner of the real estate, wherein the instrument specifies that the service company must be contacted and the lien must be released by the service company prior to final closing on any sale, mortgage or other transaction involving the real estate. The instrument is recorded at block 12, thus providing public notice of the lien and its required release in accordance with applicable laws and regulations. Assurance is given by the lender to the true owner, preferably in a written contract, that when a request to release the lien is made, before releasing the lien, the lender will investigate and confirm that the true owner is aware of the sale, mortgage or other transaction and that the true owner is not being fraudulently represented in the sale, mortgage or other transaction.

Typically during an interview of the true owner by the lender, security information is obtained at 14, such that the information can later be used to confirm the true owner's identity. This information is compiled and documented at block 16, typically using a computer or computer system. Periodically the information is analyzed at decision block 18 to determine if additional information or updating is necessary. If necessary, additional or updated security information is compiled and documented at block 16.

When the lender is requested to release the lien at block 20, the lender contacts the owner, as indicated by block 22, and confirms the true owner's identity at decision block 24 based on the compiled security information. The lender establishes whether the true owner is aware of the transaction involving the real estate, thus determining if the true owner is being fraudulently represented at decision block 26. If the owner is aware of and agrees with the transaction, and is confirmed to be the true owner based on the documented security information, then the lien is typically released at block 28. However, if fraudulent activity is confirmed, i.e., the true owner was not aware of the attempted transaction, or if the person contacted is not true owner and is fraudulently representing the true owner, then the transaction is terminated and preferably the appropriate law enforcement officials are notified, as indicated by block 30.

In another preferred embodiment, a method of the present invention to prevent fraudulent conveyance, mortgaging or other fraudulent transactions and encumbrances involving the real estate comprises the following steps. A written instrument is executed wherein a lien on the real estate is obtained by a lender in exchange for a loan of money to a true owner of the real estate. The instrument specifies that the lender must be contacted and a payoff statement obtained prior to closing any transaction involving the real estate. The written instrument is then recorded so as to give public notice of the lien and its requirements according to applicable laws and regulations. Private security information evidencing the true owner's identity is compiled and documented. The lender and the owner of the real estate enter into a contract whereby when requested to release the lien, the lender is required to investigate and confirm that the true owner is aware of the transaction and to confirm that the true owner is not being fraudulently represented in the transaction prior to release of the lien by the lender. The private information is periodically updated.

A real estate equity protection system is also provided. The system comprises a written and recorded instrument as described above; a means for documenting and maintaining personal and private information as evidence of a true owner's identity; and a means for confirming, upon receiving notice of an impending sale, mortgage or other transaction involving the real estate, the true owner's identity based on the documented personal and private information, and for insuring that the true owner is aware of, and is not being fraudulently represented in, the sale mortgage or other transaction.

In order to further illustrate the methods of the present invention, the following examples are given.

### EXAMPLE 1

Mr. Smith purchases a home in Oklahoma County, Okla., for $150,000. Twenty years later Mr. Smith has established significant equity in the home. Mr. Smith hears about several incidents where homeowners were evicted from their own homes because of an imposter who stole the homeowner's identity and then sold or mortgaged the homeowner's residence. Mr. Smith contacts The Company, a service company which provides a home equity and fraud protection service. The Company enters into a written contract with Mr. Smith wherein, for a fee of $600, The Company compiles and documents evidence of Mr. Smith's identity. The first $100 of the fee is paid up front and the remaining $500 is credited to Mr. Smith. In exchange for the $500 credit, The Company is given a lien on Mr. Smith's home. The lien is a written and signed document, or instrument, specifying that The Company must be contacted and the lien must be paid off and then released by The Company prior to any sale, mortgage or other transaction involving the real property, i.e., Mr. Smith's home. The lien instrument gives the necessary information for contacting The Company and contains an acknowledgment properly signed by Mr. Smith declaring that he is agreeing to the instrument voluntarily and without coercion.

The Company then submits the lien to the Oklahoma County Recorder. As soon as the instrument is submitted it is considered “filed for recording.” The Company is charged a recording fee which is prepaid before the lien can be fully recorded.

The Company also interviews Mr. Smith to obtain security information including his birth date, birth place, social security number, driver's license number, employer, telephone numbers, and email address. This information is fairly standard. The Company then obtains security information from Mr. Smith that is known only by Mr. Smith and possibly close friends and family. The personal information includes his mother's maiden name, the name of his first dog, the maiden name of his first girl friend, the account number for his department store credit card, and a photograph. Mr. Smith is given a document containing his personal security pass. The security pass is a random, 10-digit, alphanumeric figure and Mr. Smith is instructed to keep this document in a safe and secure place. The security information, including Mr. Smith's security pass, is documented and filed at The Company on its computer system and backed up with paper copies.

Two years after recording the lien, The Company's computer system warns that it is time to update Mr. Smith's file. The Company contacts Mr. Smith to review and update the personal information. Information such as the department store credit card and work phone number has changed and the new information is documented and filed at The Company. Mr. Smith has kept his personal security pass safe so there is no need to reissue this.

About one year later, Criminal reviews the deeds at the county recorder's office. Criminal sees that the deed to Mr. Smith's home is nearly paid off. Based on the sale price and recent appraisals of nearby homes, Criminal estimates the value of Mr. Smith's house to be roughly $240,000. He sees the lien for $500 but ignores it since it will not significantly affect the dollar amount of the equity in this real estate. Criminal can readily obtain fraudulent driver's licenses and credit cards and does so for the purpose of illegally assuming Mr. Smith's identity. Criminal, pretending to be Mr. Smith, then visits a lender in a nearby city who has been advertising low interest rate mortgages. The local lender establishes that Mr. Smith has about $180,000 collateral in his home and offers to prepare paperwork for a $120,000 mortgage so that “Mr. Smith” can contract construction of a pool, porch and guest room addition to his home. The local lender requires little time to prepare the paperwork and asks “Mr. Smith,” actually Criminal, to come back tomorrow.

Having seen the $500 lien to The Company and the requirement that The Company be contacted and the lien paid and released by The Company prior to any sale, mortgage or other transaction involving the real property, the local lender telephones The Company for a written payoff statement. (The payoff statement is necessary to calculate a CLTV (combined loan to value) required for Title insurance.) The Company takes the information promising to provide a payoff statement promptly and to release the lien according to the terms of the payoff statement.

The Company then contacts Mr. Smith using the updated work phone number in its computer system and files. When The Company contacts Mr. Smith it is discovered that he has no idea about the pending mortgage. Mr. Smith correctly answers the security questions on file and provides the correct security code later that afternoon. The Company contacts the local lender and explains that the person attempting to obtain the mortgage from them is an imposter and for this reason The Company must refuse to provide a payoff statement and must refuse to release the lien. The Company then contacts the local police department and the FBI and describes the fraud in progress. Criminal is apprehended at the closing agent's office at closing.

### EXAMPLE 2

Ms. Jones purchases a home in Oklahoma County, Okla., for $250,000. At the time of purchase, Ms. Jones is offered the opportunity to also purchase a home equity protection plan offered by The Company. The Company enters into a written contract with Ms. Jones wherein, for a fee of $700, The Company compiles and documents evidence of Ms. Jones's identity. The first $100 of the fee is paid up front and the remaining $600 is owed by Ms. Jones. The Company is given a lien on Ms. Jones's home. The lien instrument specifies that The Company must be contacted and the lien must be released by The Company prior to any sale, mortgage or other transaction involving the real property, i.e., Ms. Jones's home. The lien instrument gives the necessary information for contacting The Company and contains an acknowledgment properly signed by Ms. Jones declaring that she is agreeing to the instrument voluntarily and without coercion.

The Company then submits the lien to the Oklahoma County Recorder. As soon as the instrument is submitted it is considered “filed for recording.” The Company is charged a recording fee which is prepaid before the lien can be fully recorded.

The Company also interviews Ms. Jones to obtain the standard security information including birth date, birth place, social security number, driver's license number, employer, telephone numbers, and email address. The Company then obtains more private and personal security information from Ms. Jones including her mother's maiden name, the name of her first dog, the maiden name of her best friend in high school, the account number for her department store credit card, and a recent photograph. Ms. Jones is asked to supply one of the questions herself and she suggests, “Who was your Maid of Honor at your wedding?” Ms. Jones is issued a personal security pass which is a random eleven-digit number as part of her security information. The security information is documented and filed on The Company's computer system. Ms. Jones stores the paper showing her security pass in her jewelry box on her dresser.

Five years after purchasing her home, Ms. Jones gets a significant salary increase and contemplates some home improvement projects including a covered patio and pool. She visits a local lender who has been advertising low interest rate mortgages. The local lender establishes that Ms. Jones has about $60,000 collateral in her home and offers to prepare paperwork for a $40,000 mortgage.

Having seen the $600 lien to The Company and the requirement that The Company be contacted and the lien paid off and released by The Company prior to any sale, mortgage or other transaction involving the real property, the local lender telephones The Company. The Company Representative takes the information, enters Ms. Jones's name and property address into the computer system, and the computer accesses Ms. Jones's file. The Company Representative promises local lender to promptly provide a written payoff statement and instructions. The Company Representative then contacts Ms. Jones using the work phone number in its files. Ms. Jones informs The Company that she has indeed requested the mortgage. To confirm that they are talking to the true owner, Ms. Jones, The Company Representative requests that Ms. Jones answer the security questions including providing the security pass number in her file. The Company Representative compares Ms. Jones' answers to those displayed on the screen as shown below.

The questions are recited by The Company Representative to Ms. Jones. Ms. Jones correctly answers the questions, but has to go home to get the paper revealing her security pass. The next day, Ms. Jones recites her security pass to The Company, thus confirming her true identity. The Company Representative then issues Ms. Jones a Closing Code to be taken to the closing and enters the Closing Code into her computer file. The Company provides local lender with a written payoff statement reciting that $600 is owed and instructing that a Closing Code be provided by Ms. Jones and confirmed by The Company.

At closing, Ms. Jones provides the Closing Code, local lender confirms the code with The Company, and The Company promptly releases the lien. The $600 is collected in escrow and paid directly to The Company.

### Example Computer Screen

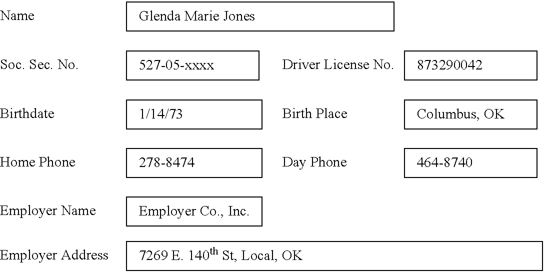

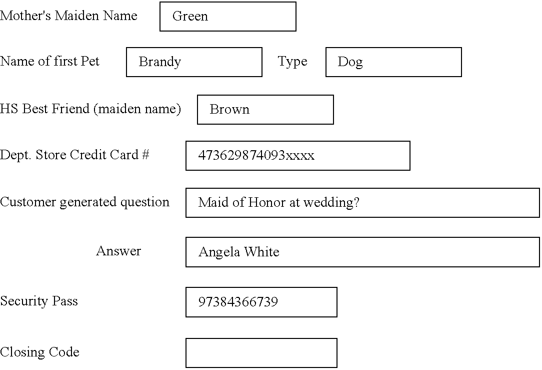

### EXAMPLE 3

Below is an example mortgage which is executed and filed in accordance with this invention.

[image]

### EXAMPLE 4

Below is an example mortgage with language identifying the mortgage as a theft and fraud prevention mechanism.

[image]

In an example using the above mortgage, Criminal again browses the deeds at the county recorder's office looking for a deeded home in an upper class neighborhood likely to have significant equity. Criminal finds such a home; however, recorded with the deed is the lien above boldly described as a means to prevent identity theft and fraud. When Criminal sees the language related to identity theft and fraud prevention, he quickly discards any deceitful notions with respect to this particular residence and instead chooses a home having no such lien.

Thus, the present invention is well adapted to carry out the objects and attain the advantages described above as well as those that are inherent therein. While numerous changes can be made by those skilled in the art, such changes are encompassed within the spirit of this invention as defined by the appended claims.

1. A method for protecting real estate and/or a true owner's equity therein from fraudulent conveyance, mortgaging or other fraudulent transactions and encumbrances involving the real estate comprising:
(a) executing a written instrument comprising a lien on the real estate;
(b) recording the written instrument so as to give public notice according to applicable laws and regulations;
(c) compiling and documenting personal information evidencing the true owner's identity;
(d) based on said personal information, verifying, when notice of a pending transfer or encumbrance of the real estate is received, that the one attempting to transfer or encumber the real estate is in fact the true owner.

2. The method of claim 1 wherein the real estate is a private home.

3. The method of claim 1 wherein the written instrument specifies a lien holder and includes a requirement that the lien holder be contacted and notified prior to closing any mortgage, conveyance or other encumbrance involving the real estate.

4. The method of claim 1 wherein the written instrument further specifies that the lien must be paid prior to release.

5. The method of claim 1 wherein the written instrument further specifies that the lien can be released only by obtaining a payoff statement from a holder of the lien.

6. The method of claim 5 further comprising preparing a payoff statement, said payoff statement requiring that the true owner present a closing pass prior to closing; and issuing a closing pass to the true owner after the true owner's identity is verified.

7. The method of claim 6 wherein the closing pass comprises figures selected from the group consisting of letters, words, numbers, symbols, designs and combinations thereof.

8. The method of claim 1 wherein said written instrument further specifies that in the event of a title or abstract search on the real estate by a real estate professional, the professional is requested to notify a holder of the lien.

9. The method of claim 8 wherein the written instrument defines the real estate professional as being selected from the group consisting of real estate agent, closing agent, title company and attorney.

10. The method of claim 1 wherein said written instrument further includes language identifying the lien as a means to prevent identity theft and fraud.

11. The method of claim 1 wherein said personal information comprises personal and private information known only by the true owner.

12. The method of claim 1 wherein said personal information comprises information selected from the group consisting of mother's maiden name, pet's name, birth date, birth city, father's middle name, name of best friend in grade school, schools attended and dates, musical instruments played, ethnic background, race, eye color, and combinations thereof.

13. The method of claim 1 wherein said personal information comprises a question and answer generated by the true owner.

14. The method of claim 1 wherein said personal information comprises a photograph of the true owner.

15. The method of claim 1 wherein said personal information comprises names and contact information of individuals who can testify to the true owner's identity by sight.

16. The method of claim 1 wherein said personal information comprises a security code.

17. The method of claim 16 wherein said security code comprises figures selected from the group consisting of letters, words, numbers, symbols, designs or combinations thereof.

18. The method of claim 1 further comprising periodically updating the personal information.

19. The method of claim 1 further comprising releasing the lien if the one attempting to transfer or encumber the real estate is in fact the true owner.

20. A method for protecting real estate and/or a true owner's equity therein from fraudulent conveyance, mortgaging or other fraudulent transactions and encumbrances involving the real estate comprising:
(a) executing a written instrument wherein a lien on the real estate is obtained by a lender in exchange for a loan of money or service to a true owner of the real estate and wherein the instrument specifies that the lender must be contacted and a payoff statement obtained prior to closing any transaction involving the real estate;
(b) recording the written instrument so as to give public notice of the lien and its requirements according to applicable laws and regulations;
(c) compiling and documenting personal information evidencing the true owner's identity;
(d) executing a contract between the lender and the true owner of the real estate whereby when requested to release the lien, the lender is required to investigate that the true owner is aware of the pending transaction and to confirm that the true owner is not being fraudulently represented in the transaction prior to release of the lien by the lender; and
(e) periodically updating the personal information.

21. A real estate equity protection system that comprises:
(a) a written instrument, recordable so as to provide public notice, comprising a mortgage whereby a lien on the real estate is provided to a service company in exchange for a loan of money or service to a true owner of the real estate;
(b) means for documenting and maintaining personal information as evidence of the true owner's identity; and
(c) means for confirming, upon receiving notice of a pending sale, mortgage or other transaction involving the real estate, the true owner's identity based on the documented personal information, and for confirming that the true owner is aware of the sale, mortgage or other transaction and that the true owner is not being fraudulently represented in the sale, mortgage or other transaction.

22. The system of claim 21, wherein the instrument specifies that the service company must be contacted and a payoff statement obtained prior to closing any sale, mortgage or other transaction involving the real estate.

23. The system of claim 21 wherein the means for documenting and maintaining the personal information comprises a computer.

24. The system of claim 21 wherein the means for documenting and maintaining the personal information comprises a computer system backed up by a manual filing system.

25. The system of claim 21 wherein the security information comprises a security code.
